(19) United States
(12) Patent Application Publication
(10) Pub. No.: US 2024/0361196 A1
(43) Pub. Date: Oct. 31, 2024

(54) SENSOR

(71) Applicant: ROHM CO., LTD., Kyoto (JP)

(72) Inventor: Masahiro SAKURAGI, Kyoto (JP)

(73) Assignee: ROHM CO., LTD., Kyoto (JP)

(21) Appl. No.: 18/635,919

(22) Filed: Apr. 15, 2024

(30) Foreign Application Priority Data
Apr. 27, 2023 (JP) 2023-073254

(51) Int. Cl. G01L 9/00

(52) U.S. Cl. CPC G01L 9/0051

(57) ABSTRACT

A sensor includes a substrate. A cavity is formed in the substrate. The substrate includes a membrane spaced from and facing a bottom surface of the cavity. A first depressed portion is formed in a central portion of the cavity as seen in a plan view.

### CROSS REFERENCE TO RELATED APPLICATIONS

This nonprovisional application is based on Japanese Patent Application No. 2023-073254 filed on Apr. 27, 2023 with the Japan Patent Office, the entire contents of which are hereby incorporated by reference.

### BACKGROUND OF THE INVENTION

### Field of the Invention

The present disclosure relates to a sensor.

### Description of the Background Art

For example, Japanese Patent Laying-Open No. 2021-25966 discloses a MEMS (Micro Electro Mechanical System) sensor. The MEMS sensor disclosed in Japanese Patent Laying-Open No. 2021-25966 includes a substrate. The substrate includes a first substrate and a second substrate. The first substrate and the second substrate are formed from monocrystalline silicon. The first substrate has a first surface and a second surface. The first surface and the second surface are end surfaces in the thickness direction of the first substrate. A cavity is formed in the second surface. The cavity is depressed toward the first surface. The second substrate is disposed on the second surface. Thus, the cavity is formed in the substrate. The first substrate and the second substrate are bonded to each other. A portion of the second substrate that is spaced from and faces the bottom surface of the cavity forms a membrane (diaphragm).

The MEMS sensor disclosed in Japanese Patent Laying-Open No. 2021-25966 operates by flexing the membrane under an external pressure. In the MEMS sensor disclosed in Japanese Patent Laying-Open No. 2021-25966, the depth of the cavity is designed in such a manner that the membrane and the bottom surface of the cavity are not brought into contact with each other by a pressure in a normal state of use. However, the membrane may be brought into contact with the bottom surface of the cavity due to, for example, the pressure of water used in a dicing step in which a blade is used, cleaning during substrate packaging, ultrasonic cleaning, blowing, or the like. Such contact of the membrane with the bottom surface of the cavity is a cause of damage to the membrane.

The sensor of the present disclosure includes a substrate. A cavity is formed in the substrate. The substrate includes a membrane spaced from and facing a bottom surface of the cavity. A first depressed portion is formed in a central portion of the cavity as seen in a plan view.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a sensor 100.

FIG. 2 is a cross-sectional view taken along II-II in FIG. 1.

FIG. 3 is a cross-sectional view taken along III-III in FIG. 2.

FIG. 4 is a cross-sectional view of a sensor 100 according to Modification 1.

FIG. 5 is a cross-sectional view of a sensor 100 according to Modification 2.

FIG. 6 is a cross-sectional view of a sensor 100 according to Modification 3.

FIG. 7 is a cross-sectional view of a sensor 100 according to Modification 4.

FIG. 8 is a manufacturing process diagram for a sensor 100.

FIG. 9 is a cross-sectional view illustrating a hard mask formation step S2.

FIG. 10 is a cross-sectional view illustrating a resist pattern formation step S3.

FIG. 11 is a cross-sectional view illustrating a first etching step S4.

FIG. 12 is a cross-sectional view illustrating a second etching step S5.

FIG. 13 is a cross-sectional view illustrating a third etching step S6.

FIG. 14 is a cross-sectional view illustrating a substrate bonding step S7.

FIG. 15 is a cross-sectional view illustrating a first insulating film formation step S8.

FIG. 16 is a cross-sectional view illustrating a first ion implantation step S9.

FIG. 17 is a cross-sectional view illustrating a second insulating film formation step S10.

FIG. 18 is a cross-sectional view illustrating a contact hole formation step S11.

FIG. 19 is a cross-sectional view illustrating a second ion implantation step S12.

FIG. 20 is a cross-sectional view illustrating a pad formation step S13.

FIG. 21 is a cross-sectional view illustrating a protective film formation step S14.

FIG. 22 is a cross-sectional view of a sensor 100A.

FIG. 23 is a cross-sectional view of a sensor 100B.

### DESCRIPTION OF THE PREFERRED EMBODIMENTS

Embodiments of the present disclosure are described with reference to the drawings. In the following drawings, the same or corresponding parts are denoted by the same reference characters, and a description thereof is not herein repeated. A sensor according to the embodiments is herein referred to as sensor 100.

### (Configuration of Sensor 100)

A configuration of sensor 100 is described in the following.

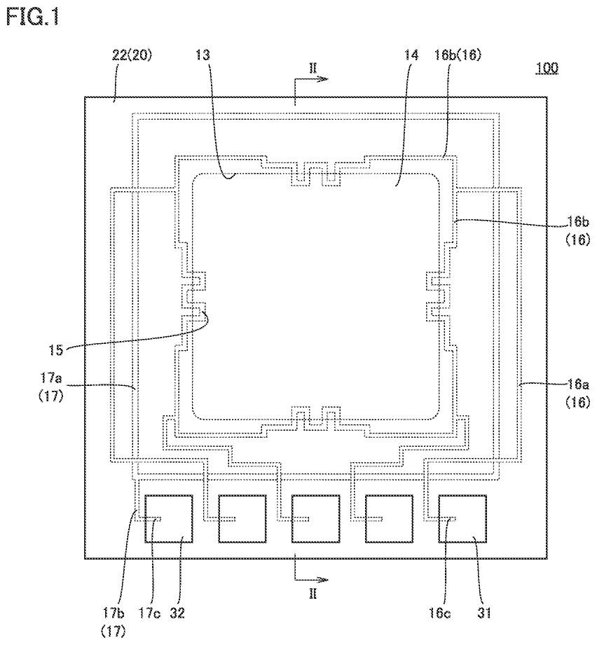

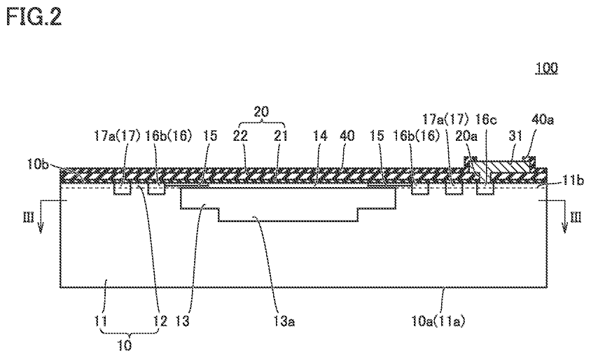

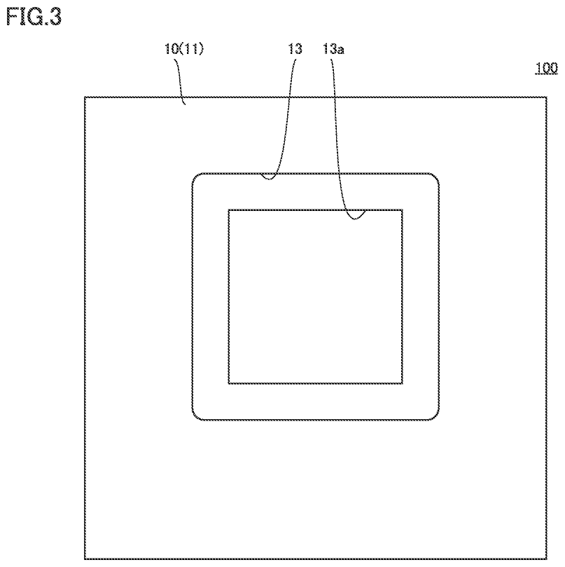

FIG. 1 is a plan view of sensor 100. In FIG. 1, a protective film 40 is not shown. FIG. 2 is a cross-sectional view taken along II-II in FIG. 1. FIG. 3 is a cross-sectional view taken along III-III in FIG. 2. As shown in FIGS. 1 to 3, sensor 100 includes a substrate 10, an insulating film 20, a plurality of pads 31, a pad 32, and protective film 40.

Substrate 10 has a first surface 10a and a second surface 10b. First surface 10a and second surface 10b are respectively opposite end surfaces in the thickness direction of substrate 10. Substrate 10 includes, for example, a first substrate 11 and a second substrate 12. The material forming first substrate 11 and second substrate 12 is, for example, monocrystalline silicon. The conductivity type of first substrate 11 and the conductivity type of second substrate 12 are a first conductivity type. The first conductivity type is, for example, n type.

First substrate 11 has a first surface 11a and a second surface 11b. First surface 11a and second surface 11b are respectively opposite end surfaces in the thickness direction of first substrate 11. First surface 11a forms first surface 10a. Second substrate 12 is disposed on second surface 11b. First substrate 11 and second substrate 12 are bonded to each other.

A cavity 13 is formed in second surface 11b. Cavity 13 has a rectangular shape as seen in a plan view. The “rectangular shape” includes the one having rounded corners. Second surface 11b is depressed toward first surface 11a (first surface 10a) in cavity 13. As described above, second substrate 12 is disposed on second surface 11b, and therefore, cavity 13 is formed in substrate 10.

A first depressed portion 13a is formed in the bottom surface of cavity 13. First depressed portion 13a has a rectangular shape as seen in plan view. The bottom surface of cavity 13 is depressed toward first surface 11a (first surface 10a) in first depressed portion 13a.

Second substrate 12 includes a membrane 14. Membrane 14 is a part of second substrate 12 that is spaced from and faces the bottom surface of cavity 13. The distance between membrane 14 and the bottom surface of cavity 13 is preferably 0.05 times or less as large as the thickness of substrate 10. The distance between membrane 14 and the bottom surface of first depressed portion 13a is preferably 0.075 times or more as large as the thickness of substrate 10.

A plurality of resistors 15 are formed on membrane 14. Resistor 15 is formed on second surface 10b. Resistor 15 is formed by implanting a dopant. The conductivity type of resistor 15 is a second conductivity type. The second conductivity type is, for example, p type. In the example shown in FIG. 1, the number of a plurality of resistors 15 is four. Each of a plurality of resistors 15 is disposed on the outer edge of membrane 14 along a respective side of membrane 14 as seen in a plan view.

A plurality of interconnects 16 are further formed on substrate 10. Interconnects 16 are formed on second surface 10b. Interconnects 16 are arranged mainly to avoid membrane 14. Interconnect 16 is formed by implanting a dopant. The conductivity type of interconnect 16 is the second conductivity type.

Interconnects 16 include a first portion 16a and two second portions 16b. One end of first portion 16a is electrically connected to a contact 16c. Contact 16c is formed by implanting a dopant. The conductivity type of contact 16c is the second conductivity type. Contact 16c overlaps pad 31 as seen in a plan view.

Interconnect 16 is branched, at one end of first portion 16a, into two second portions 16b. One of second portions 16b is electrically connected to one of a plurality of resistors 15, and the other one of second portions 16b is electrically connected to another one of a plurality of resistors 15. In this way, a plurality of resistors 15 are connected by a plurality of interconnects 16 to form a bridge circuit.

An interconnect 17 is further formed on substrate 10. Interconnect 17 is formed on second surface 10b. Interconnect 17 is arranged to avoid membrane 14. Interconnect 17 is formed by implanting a dopant. The conductivity type of interconnect 17 is the first conductivity type. Interconnect 17 includes a first portion 17a and a second portion 17b. First portion 17a is formed in an annular shape as seen in a plan view. One end of second portion 17b is electrically connected to first portion 17a. The other end of second portion 17b is electrically connected to a contact 17c. Contact 17c is formed by implanting a dopant. The conductivity type of contact 17c is the first conductivity type. Contact 17c overlaps pad 32 as seen in a plan view.

Insulating film 20 is disposed on second surface 10b. Insulating film 20 includes, for example, a first insulating film 21 and a second insulating film 22. First insulating film 21 is disposed on second surface 10b. Second insulating film 22 is disposed on first insulating film 21. First insulating film 21 and second insulating film 22 are formed, for example, from silicon oxide. A contact hole 20a is formed in insulating film 20. A contact hole 20b (not shown) is formed in insulating film 20. Contact hole 20a and contact hole 20b extend through insulating film 20 in the thickness direction. Contact 16c and contact 17c are exposed from contact hole 20a and contact hole 20b, respectively.

Pad 31 is disposed on insulating film 20. Pad 31 is electrically connected to contact 16c by being embedded in contact hole 20a. Pad 32 is disposed on insulating film 20. Pad 32 is electrically connected to contact 17c by being embedded in contact hole 20b. A plurality of pads 31 and pad 32 are arranged, for example, in a line as seen in a plan view.

For example, a power supply voltage is supplied to a pair of pads 31 that are electrically connected to resistor 15. As the external pressure (e.g., atmospheric pressure) changes, membrane 14 is flexed due to a difference from the pressure in cavity 13. As membrane 14 is flexed, the value of the electrical resistance of resistor 15 changes. As the value of the electrical resistance of resistor 15 changes, the voltage between pads 31 of a pad pair that are electrically connected to resistor 15 changes. Sensor 100 is capable of detecting the external pressure by detecting this voltage change. Specifically, sensor 100 is, for example, a pressure sensor such as an atmospheric pressure sensor. For example, a substrate potential is supplied to substrate 10 through pad 32.

Protective film 40 is disposed on insulating film 20 so as to cover a plurality of pads 31 and pad 32. A plurality of openings 40a are formed in protective film 40. An opening 40b (not shown) is formed in protective film 40. Openings 40a and opening 40b extend through protective film 40 in the thickness direction. A plurality of pads 31 are exposed from respective openings 40a. Pad 32 is exposed from opening 40b. Protective film 40 is formed, for example, from silicon nitride.

### (Modification 1)

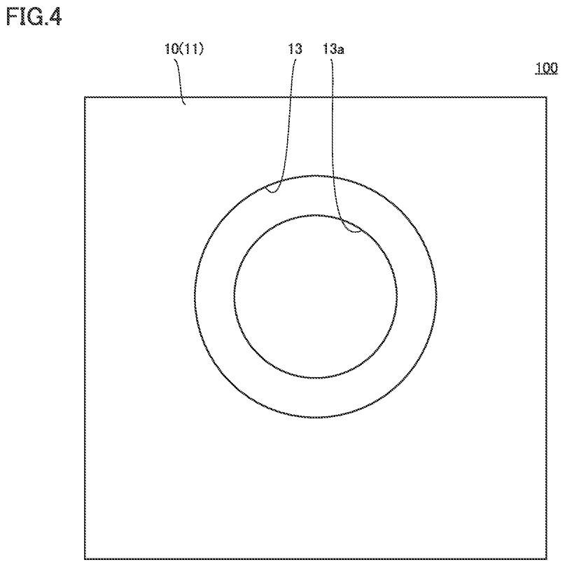

FIG. 4 is a cross-sectional view of a sensor 100 according to Modification 1. FIG. 4 shows a cross section taken at a position corresponding to FIG. 3. As shown in FIG. 4, cavity 13 and first depressed portion 13a may be circular as seen in a plan view. Namely, the shape of cavity 13 and the shape of first depressed portion 13a as seen in a plan view are not particularly limited.

### (Modification 2 and Modification 3)

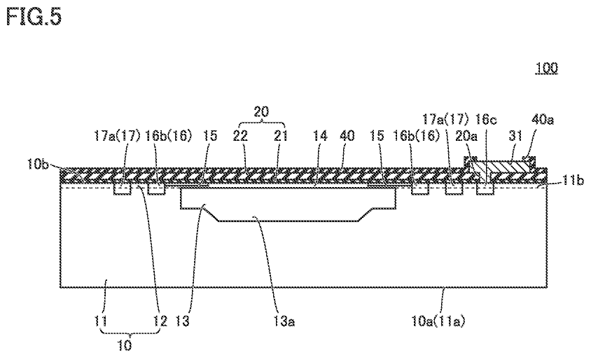

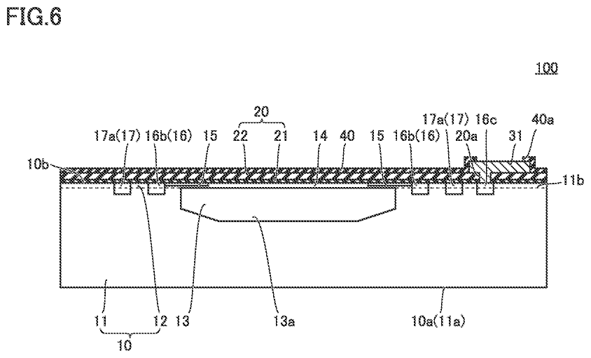

FIG. 5 is a cross-sectional view of a sensor 100 according to Modification 2. FIG. 6 is a cross-sectional view of a sensor 100 according to Modification 3. FIGS. 5 and 6 show respective cross sections each taken at a position corresponding to FIG. 2. As shown in FIGS. 5 and 6, the side surface of first depressed portion 13a may be inclined such that the width of first depressed portion 13a decreases toward the bottom surface of first depressed portion 13a. As shown in FIG. 6, the upper end of the side surface of first depressed portion 13a may be contiguous to the lower end of the side surface of cavity 13.

### (Modification 4)

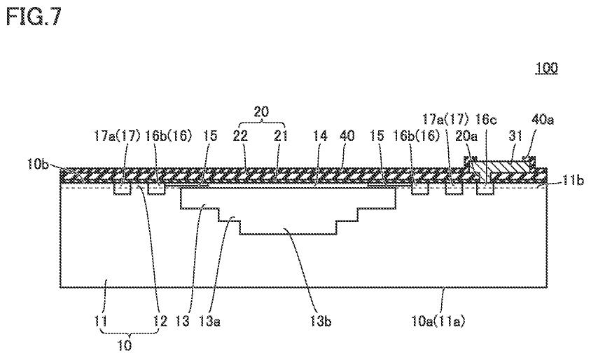

FIG. 7 is a cross-sectional view of a sensor 100 according to Modification 4. As shown in FIG. 7, a second depressed portion 13b may be formed in a central portion of the bottom surface of first depressed portion 13a as seen in a plan view. The bottom surface of first depressed portion 13a is depressed toward first surface 11a (first surface 10a) in second depressed portion 13b. While the foregoing illustrates depressed portions in two steps formed in the bottom surface of cavity 13, the number of steps of the depressed portions formed in the bottom surface of cavity 13 is not limited to this but may be three or more.

### (Method for Manufacturing Sensor 100)

A method for manufacturing sensor 100 is described in the following.

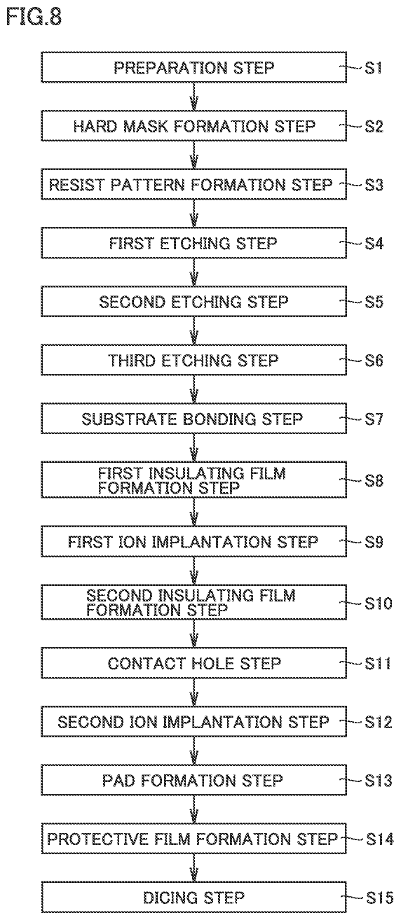

FIG. 8 is a manufacturing process diagram for sensor 100. As shown in FIG. 8, the method for manufacturing sensor 100 includes a preparation step S1, a hard mask formation step S2, a resist pattern formation step S3, a first etching step S4, a second etching step S5, a third etching step S6, a substrate bonding step S7, a first insulating film formation step S8, a first ion implantation step S9, a second insulating film formation step S10, a contact hole formation step S11, a second ion implantation step S12, a pad formation step S13, a protective film formation step S14, and a dicing step S15.

In preparation step S1, first substrate 11 is prepared. After preparation step S1, hard mask formation step S2 is performed.

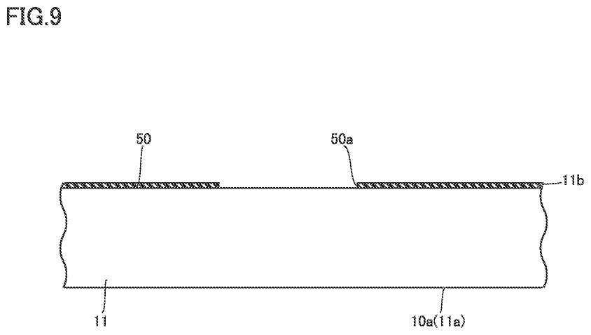

FIG. 9 is a cross-sectional view illustrating hard mask formation step S2. As shown in FIG. 9, in hard mask formation step S2, a hard mask 50 is formed. Hard mask 50 is formed, for example, from silicon oxide. Hard mask 50 has an opening 50a. In hard mask formation step S2, firstly a constituent material of hard mask 50 is deposited on second surface 11b by, for example, thermal oxidation. Secondly, a resist pattern is formed on the deposited constituent material of hard mask 50. The resist pattern is formed by applying a photoresist and exposing and developing the applied photoresist. Thirdly, the deposited constituent material of hard mask 50 is etched using the resist pattern as a mask. After hard mask formation step S2, resist pattern formation step S3 is performed.

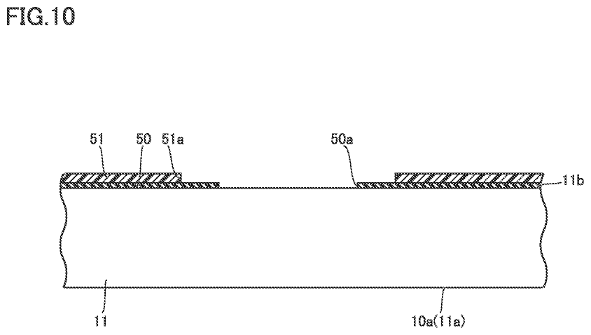

FIG. 10 is a cross-sectional view illustrating resist pattern formation step S3. As shown in FIG. 10, in resist pattern formation step S3, a resist pattern 51 is formed on hard mask 50. Resist pattern 51 has an opening 51a. The opening edge of opening 50a is located inside the opening edge of opening 51a. Resist pattern 51 is formed by applying a photoresist on hard mask 50 and exposing and developing the applied photoresist. After resist pattern formation step S3, first etching step S4 is performed.

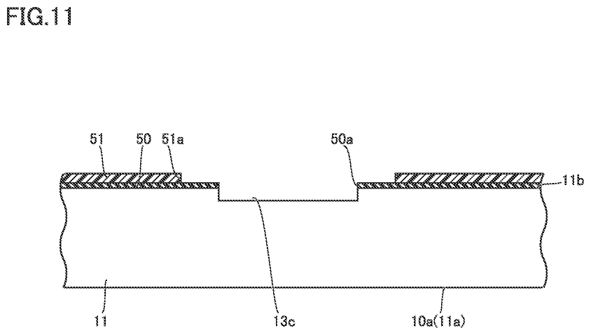

FIG. 11 is a cross-sectional view illustrating first etching step S4. As shown in FIG. 11, in first etching step S4, first substrate 11 is etched using hard mask 50. This etching is anisotropic dry etching, for example. Accordingly, depressed portion 13c is formed in second surface 11b. After first etching step S4, second etching step S5 is performed.

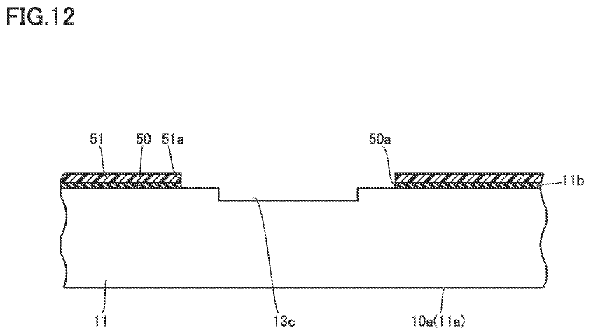

FIG. 12 is a cross-sectional view illustrating second etching step S5. As shown in FIG. 12, in second etching step S5, hard mask 50 is etched using resist pattern 51. This etching is anisotropic dry etching, for example. Accordingly, the opening edge of opening 50a is retracted to the opening edge of opening 51a. After second etching step S5, third etching step S6 is performed.

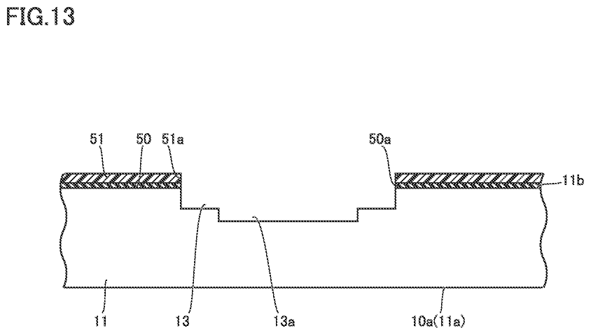

FIG. 13 is a cross-sectional view illustrating third etching step S6. As shown in FIG. 13, in third etching step S6, first substrate 11 is etched using hard mask 50 and resist pattern 51. This etching is anisotropic dry etching, for example. Accordingly, second surface 11b exposed from opening 50a (opening 51a) is etched down to form cavity 13 and first depressed portion 13a. After third etching step S6, hard mask 50 and resist pattern 51 are removed. After third etching step S6, substrate bonding step S7 is performed.

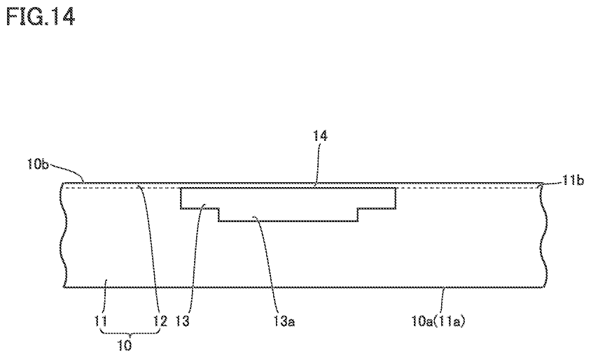

FIG. 14 is a cross-sectional view illustrating substrate bonding step S7. As shown in FIG. 14, in substrate bonding step S7, second substrate 12 is bonded to first substrate 11 (second surface 11b). In substrate bonding step S7, firstly second substrate 12 is disposed on second surface 11b. Secondly, second substrate 12 is heated while being subjected to a pressure applied toward second surface 11b. Accordingly, second substrate 12 is bonded to second surface 11b. After substrate bonding step S7, first insulating film formation step S8 is performed.

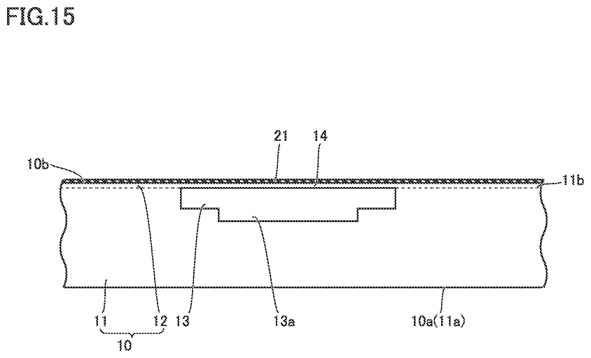

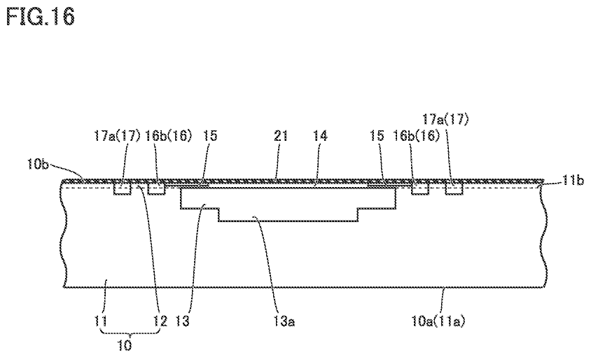

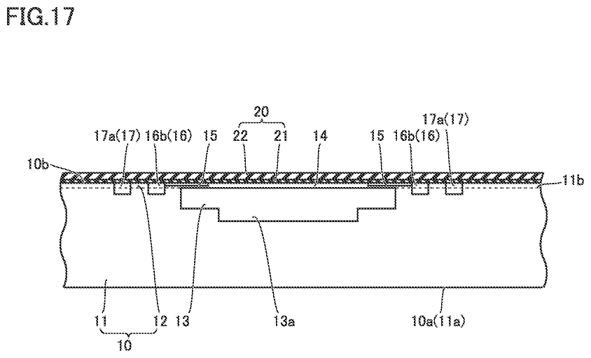

FIG. 15 is a cross-sectional view illustrating first insulating film formation step S8. As shown in FIG. 15, in first insulating film formation step S8, substrate 10 is thermally oxidized, for example, to form first insulating film 21 on second surface 10b. After first insulating film formation step S8, first ion implantation step S9 is performed. FIG. 16 is a cross-sectional view illustrating first ion implantation step S9. As shown in FIG. 16, in first ion implantation step S9, resistor 15, interconnect 16, and interconnect 17 are formed by ion implantation. After first ion implantation step S9, second insulating film formation step S10 is performed. FIG. 17 is a cross-sectional view illustrating second insulating film formation step S10. As shown in FIG. 17, in second insulating film formation step S10, second insulating film 22 is formed for example by CVD (Chemical Vapor Deposition). After second insulating film formation step S10, contact hole formation step S11 is performed.

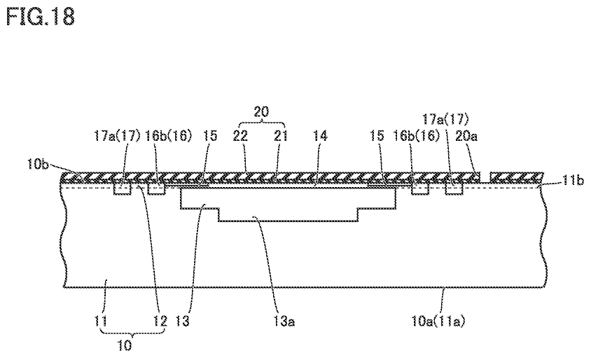

FIG. 18 is a cross-sectional view illustrating contact hole formation step S11. As shown in FIG. 18, in contact hole formation step S11, contact hole 20a is formed in insulating film 20 by anisotropic dry etching, for example. In contact hole formation step S11, contact hole 20b (not shown) is also formed by anisotropic dry etching, for example. After contact hole formation step S11, second ion implantation step S12 is performed.

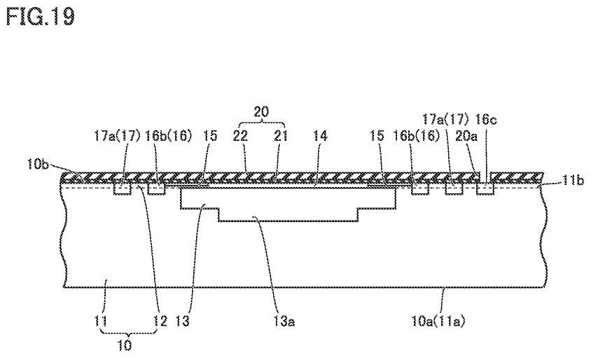

FIG. 19 is a cross-sectional view illustrating second ion implantation step S12. As shown in FIG. 19, in second ion implantation step S12, contact 16c is formed by ion implantation. In second ion implantation step S12, contact 17c (not shown) is also formed by ion implantation. After second ion implantation step S12, pad formation step S13 is performed.

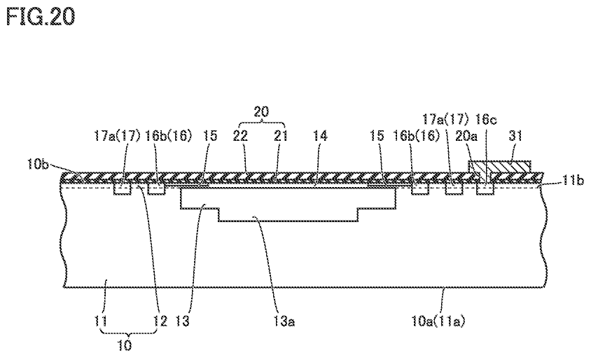

FIG. 20 is a cross-sectional view illustrating pad formation step S13. As shown in FIG. 20, in pad formation step S13, pad 31 is formed on insulating film 20. In pad formation step S13, firstly a constituent material of pad 31 is deposited on insulating film 20 by sputtering, for example. At this time, the constituent material of pad 31 is also embedded in contact hole 20a. Secondly, a resist pattern is formed on the deposited constituent material of pad 31. The resist pattern is formed by applying a photoresist and exposing and developing the applied photoresist. Thirdly, anisotropic dry etching, for example, is performed using the resist pattern, to pattern the deposited constituent material of pad 31. Pad 32 (not shown) is also formed through these steps. After pad formation step S13, protective film formation step S14 is performed.

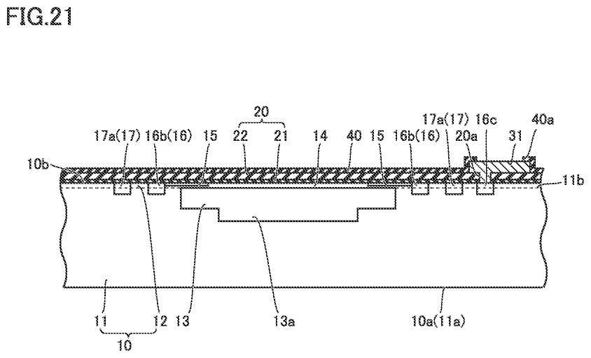

FIG. 21 is a cross-sectional view illustrating protective film formation step S14. As shown in FIG. 21, in protective film formation step S14, protective film 40 is formed. In protective film formation step S14, firstly a constituent material of protective film 40 is deposited for example by CVD to cover pads 31 and 32 (not shown). Secondly, a resist pattern is formed on the deposited constituent material of protective film 40. The resist pattern is formed by applying a photoresist and exposing and developing the applied photoresist. Thirdly, anisotropic dry etching, for example, is performed using the resist pattern, to pattern the deposited constituent material of protective film 40 and thereby form an opening 40a. Opening 40b (not shown) is also formed by the dry etching. After protective film formation step S14, dicing step S15 is performed.

In dicing step S15, substrate 10, insulating film 20, and protective film 40 are cut with a blade, for example, to be divided into a plurality of sensors 100. The cutting with a blade is performed, for example, while water is supplied. In this way, the structure of sensor 100 shown in FIGS. 1 to 3 is formed.

### (Effects of Sensor 100)

Effects of sensor 100 are described below in comparison with a sensor according to Comparative Example 1 and a sensor according to Comparative Example 2. The sensor according to Comparative Example 1 is herein referred to as sensor 100A, and the sensor according to Comparative Example 2 is herein referred to as sensor 100B.

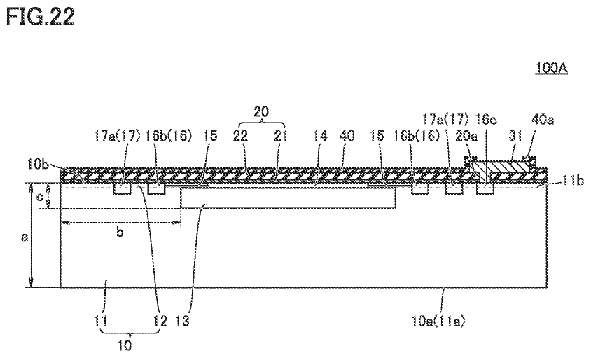

FIG. 22 is a cross-sectional view of sensor 100A. FIG. 22 shows a cross section taken at a position corresponding to FIG. 2. As shown in FIG. 22, in sensor 100A, first depressed portion 13a is not formed in the bottom surface of cavity 13. Except for this, the configuration of sensor 100A is the same as the configuration of sensor 100. In sensor 100A, the depth of cavity 13 is designed such that membrane 14 which is flexed when the external pressure increases is not brought into contact with the bottom surface of cavity 13 under a pressure in a normal state of use. However, a pressure higher than or equal to the pressure in the normal state of use may be applied to membrane 14, due to water supplied in dicing step S15, for example. As a result, in sensor 100A, membrane 14 may be brought into contact with the bottom surface of cavity 13, so that membrane 14 may be damaged.

In contrast, in sensor 100, first depressed portion 13a is formed in the bottom surface of cavity 13, and therefore, the distance between the bottom surface of cavity 13 and a central portion of membrane 14 where the membrane is flexed to a greater extent, is partially larger. As a result, in sensor 100, contact of membrane 14 with the bottom surface of cavity 13 is suppressed and, as such, damage to membrane 14 is suppressed.

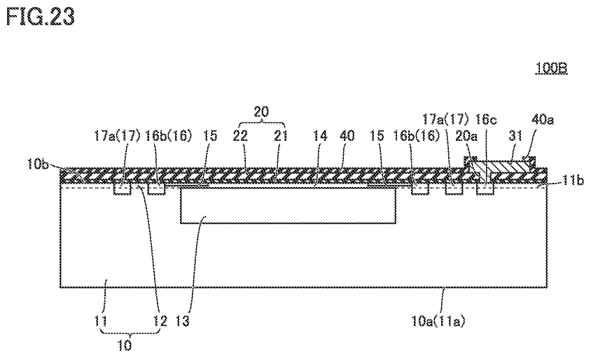

FIG. 23 is a cross-sectional view of sensor 100B. FIG. 23 shows a cross section taken at a position corresponding to FIG. 2. As shown in FIG. 23, in sensor 100B, the depth of cavity 13 is larger than that of sensor 100A. Except for this, the configuration of sensor 100B is the same as the configuration of sensor 100A. Assuming that the distance between the side surface of substrate 10 and the side surface of cavity 13 is b, the thickness of substrate 10 is a, and the distance between the bottom surface of cavity 13 and membrane 14 is c (see FIG. 22), the stress resistance to lateral stress can be expressed by: k×a×b÷c (k is a constant).

In sensor 100B, the depth of cavity 13 is larger, and therefore, contact between the bottom surface of cavity 13 and membrane 14 and resultant damage to membrane 14 due to the contact can be suppressed. However, in sensor 100B, the value of c is larger, so that the stress resistance to lateral stress is smaller. In contrast, in sensor 100, respective values of the above-defined a, b, and c are substantially identical to those of sensor 100A, and therefore, sensor 100 exhibits its stress resistance to lateral stress equivalent to that of sensor 100A. Thus, sensor 100 makes it possible to suppress contact of membrane 14 with the bottom surface of cavity 13 while maintaining the stress resistance to lateral stress.

When the distance between membrane 14 and the bottom surface of cavity 13 is 0.05 times or less as large as the thickness of substrate 10 and the distance between membrane 14 and the bottom surface of first depressed portion 13a is 0.075 times or more as large as the thickness of substrate 10, it is possible to further effectively suppress contact of membrane 14 with the bottom surface of cavity 13 while further effectively maintaining the stress resistance to lateral stress. When the side surface of first depressed portion 13a is inclined such that the width of first depressed portion 13a decreases toward the bottom surface of first depressed portion 13a, a further sufficient width of substrate 10 between the side surface of first depressed portion 13a and the side surface of substrate 10 can be ensured, and therefore, a further effective stress resistance to lateral stress can be ensured.

### (Appendixes)

The above-described embodiment includes the following features.

### <Appendix 1>

A sensor comprising a substrate, wherein
a cavity is formed in the substrate,
the substrate includes a membrane spaced from and facing a bottom surface of the cavity, and
a first depressed portion is formed in a central portion of the cavity as seen in a plan view.

### <Appendix 2>

The sensor according to Appendix 1, wherein the first depressed portion is rectangular as seen in a plan view.

### <Appendix 3>

The sensor according to Appendix 1, wherein the first depressed portion is circular as seen in a plan view.

### <Appendix 4>

The sensor according to any one of Appendixes 1 to 3, wherein a side surface of the first depressed portion is inclined such that a width of the first depressed portion decreases toward a bottom surface of the first depressed portion.

### <Appendix 5>

The sensor according to any one of Appendixes 1 to 4, wherein
a distance between the bottom surface of the cavity and the membrane is 0.05 times or less as large as a thickness of the substrate, the bottom surface of the cavity being a bottom surface located around the first depressed portion, and
a distance between a bottom surface of the first depressed portion and the membrane is 0.075 times or more as large as the thickness of the substrate.

Although the embodiments of the present invention have been described, it should be construed that the embodiments disclosed herein are given by way of illustration and example only and are not to be taken by way of limitation. It is intended that the scope of the present invention is defined by the claims and encompasses all variations equivalent in meaning and scope to the claims.

What is claimed is:

1. A sensor comprising a substrate, wherein
a cavity is formed in the substrate,
the substrate includes a membrane spaced from and facing a bottom surface of the cavity, and
a first depressed portion is formed in a central portion of the cavity as seen in a plan view.

2. The sensor according to claim 1, wherein the first depressed portion is rectangular as seen in a plan view.

3. The sensor according to claim 1, wherein the first depressed portion is circular as seen in a plan view.

4. The sensor according to claim 1, wherein a side surface of the first depressed portion is inclined such that a width of the first depressed portion decreases toward a bottom surface of the first depressed portion.

5. The sensor according to claim 1, wherein
a distance between the bottom surface of the cavity and the membrane is 0.05 times or less as large as a thickness of the substrate, the bottom surface of the cavity being a bottom surface located around the first depressed portion, and
a distance between a bottom surface of the first depressed portion and the membrane is 0.075 times or more as large as the thickness of the substrate.
